(19) United States
(12) Patent Application Publication
(10) Pub. No.: US 2026/0187072 A1
(43) Pub. Date: Jul. 2, 2026

(54) EFFICIENT JOIN OPERATIONS DURING STREAMING OF STRUCTURED DATA

(71) Applicant: Digital.ai Software, Inc., Raleigh, NC (US)

(72) Inventor: Kiran Mallekoppa Nagaraj, Bengaluru (IN)

(21) Appl. No.: 19/005,347

(22) Filed: Dec. 30, 2024

(51) Int. Cl. G06F 16/2453

(52) U.S. Cl. CPC G06F 16/24544

(57) ABSTRACT

As data from any one or multiple of multiple data streams arrives, a transformation subsystem is notified of an available data record(s). The transformation subsystem writes an available data record into a dataset (“full join dataset”) as a new record or merges the available data record with an existing record in the full join dataset that satisfies a specified join condition regardless of join type. If the join type is a full join, then the full join dataset is the target dataset. Otherwise, the transformation subsystem applies a filtering according to join type and join condition on top of the full join dataset.

### BACKGROUND

The disclosure generally relates to digital data processing and streaming data (e.g., CPC subclass G06F).

ETL (extract, transform, load) is a data integration process that was introduced in the 1970s. The ETL process extracts data from multiple data sources, cleans and organizes (i.e., transforms) the extracted data for the intended use and/or target system, and loads the transformed data into a sink or target (e.g., data warehouse or data lake).

The rise of cloud computing has introduced “ETL pipelines” or “data pipelines.” While data pipeline and ETL pipeline are sometimes used interchangeably, some use data pipeline to refer more specifically to a data integration process that includes streaming data sources or “real-time” data sources. A data flow transformation is a type of data pipeline that performs a transformation on a data source, extracting data from sources like databases, and transforming the data within the data pipeline to fit the desired structure, persisting the data into a sink.

Structured Query Language (SQL) is a domain-specific language used to manage data in relational database management system (RDBMS). In the process of transforming data, SQL is used to transform and optimize large data sets. When two data sources are merged with each other, SQL uses a JOIN operation. SQL has multiple types of join operations. A FULL JOIN, also referred to as a FULL OUTER JOIN, is a merge operation that persists all the rows of both a “left” data source and a “right” data source according to a specified join condition into a resulting dataset. A LEFT JOIN is a merge operation which persists all the rows of the left data source with mergers or combinations from rows of the right data source with matching values on the join key/column specified in the join condition. A RIGHT JOIN is a merge operation which persists all the rows of the right data source with mergers or combinations from rows in the left data source with matching values on the join key/column specified in the join condition. An INNER JOIN is a merge operation which only persists the rows from both the left and right data sources which satisfy the join condition.

### BRIEF DESCRIPTION OF THE DRAWINGS

Embodiments of the disclosure may be better understood by referencing the accompanying drawings.

FIG. 1 is a diagram of a system performing a full join on streaming datasets.

FIG. 2 is a diagram of a system performing a streaming left join on streaming datasets.

FIG. 3 is a flowchart of example operations for joining asynchronously streaming datasets.

FIG. 4 is a flowchart of example operations for effectuating an inner join on streaming datasets based on updates to a first dataset that is a full join of the streaming datasets.

FIG. 5 is a flowchart of example operations for effectuating a left/right join on streaming datasets based on updates to a first dataset that is a full join of the streaming datasets.

FIG. 6 depicts an example computer system with a streaming join transformation subsystem.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

“Streaming data” refers to ongoing transferring or moving of data from one or more sources to one or more destinations. Streaming has nuances depending on the communication layer perspective. For this description, the communication layer perspective is application layer. Thus, the streaming data is streaming records (e.g., a row or entry of a dataset), each of which is a collection of data elements/fields. The continuous aspect of streaming does not mean that arrival of data records at a destination is at fixed time intervals or never as gaps. The continuous aspect of streaming means that the data records can continue to arrive over a dynamic time period and encompasses the possibility of updates at the data source(s). Indeed, a data stream may not have an end. For instance, a data source may be a log that is continuously updated until interrupted or terminated by a command or operation external to the record collection/creation.

The description also uses the terms “repository” and “dataset.” Dataset has its plain meaning of structured data independent of any underlying data storage technology. In other words, dataset is technology agnostic. The term “repository” is used to refer to a dataset and the underlying storage technology, but not any specific storage technology. As an example, a repository may be a data lake, a relational database, a non-relational database, a key-value store, an object store, or a data warehouse.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

A common operation for transformation in a data flow is the join operation. With cloud computing, a transformation data flow will often involve joining streaming data. For instance, a software development project can involve geographically disparate teams which then leads to streaming program code updates from different sources. Performing the join after the streaming has completed presumes the streaming will complete prior to consumption of a target dataset resulting from the join and fails to accommodate ongoing streaming for an extended time period. And these issues are not addressed with batch processing of the streaming datasets at least because it suffers from latency.

A system has been created to join streaming data without the delay of batch processing despite ongoing streaming. The disclosed system includes a data ingestion subsystem and a transformation subsystem that supports a data flow or data pipeline with a join operation specified for multiple streaming datasets/data streams. As data from any one or multiple of the multiple data streams arrives, the data ingestion subsystem notifies the transformation subsystem of an available data record(s). The transformation subsystem writes an available data record into a dataset (“full join dataset”) as a new record or merges the available data record with an existing record in the full join dataset that satisfies a specified join condition regardless of join type. If the join type is a full join, then the full join dataset is the target dataset. Otherwise, the transformation subsystem applies a filtering according to join type and join condition on top of the full join dataset.

### Example Illustrations

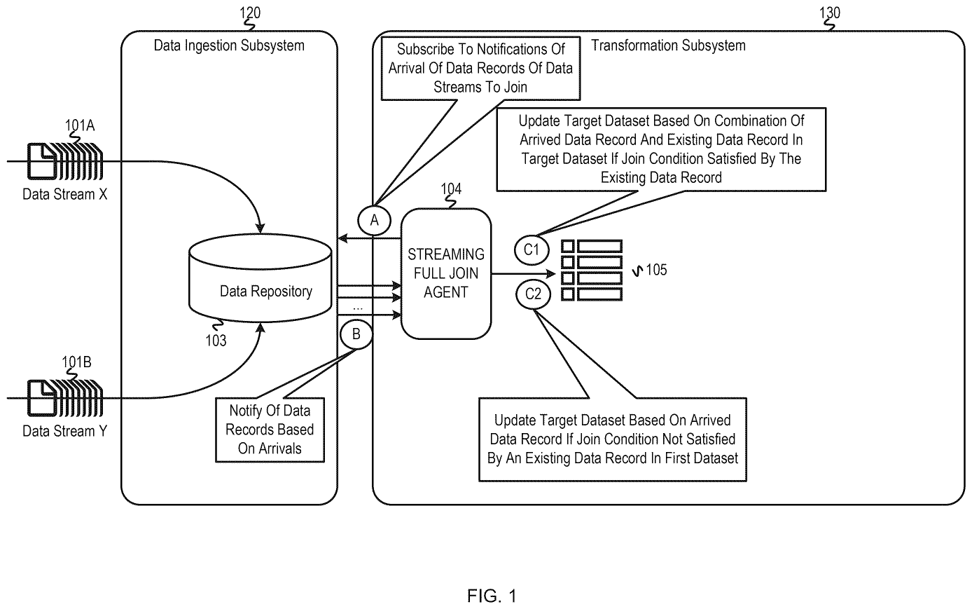

FIG. 1 is a diagram of a system performing a full join on streaming datasets. A full join is a join operation where all matching and unmatching records from one or more datasets are merged into a single dataset. Entries which match a join condition determined by the join operation are merged into singular entries, and unmatching entries are added to a dataset without performing a merge. FIG. 1 includes a data ingestion subsystem 120 and a transformation subsystem 130. As FIG. 1 is illustrating a full join of data streams, a data flow transformation or pipeline has been configured to perform a full outer join for the transformation. Accordingly, the transformation subsystem 130 instantiates a streaming full join agent 104. Two data streams 101A and 101B respectively labeled “Data Stream X” and “Data Stream Y” both feed data into a data repository 103 associated with the data ingestion subsystem 120. The data ingestion subsystem 120 receives entries from both data streams in an asynchronous manner. Upon receiving a data entry(ies)/record(s) from either of data streams 101A, 101B, records are persisted inside the data repository 103. The data ingestion subsystem 120 or another process that maintains the data repository 103 maintains metadata that indicates data source and time of arrival for records of the data streams 101A, 101B. The transformation subsystem 130, upon receiving a notification from the data ingestion subsystem 120 that a data record has arrived and is available, writes the data record into a target dataset 105.

FIG. 1 is annotated with a series of letters A, B, and C1-C2 representing stages of one or more operations each. Although these stages are ordered for this example, the stages illustrate one example to aid in understanding this disclosure and should not be used to limit the claims. Subject matter falling within the scope of the claims can vary from what is illustrated.

At stage A, the transformation subsystem 130 subscribes to notifications of arrival of data records for data streams indicated in a specified transformation operation or transformation configuration of the transformation subsystem 130. The transformation can be configured according to a transformation configuration (e.g., configuration, command, or statement) directly or indirectly authored or selected by a user. For instance, the transformation may be in accordance with a pre-defined pipeline or a triggered by another operation(s). The transformation subsystem 130 parses the transformation configuration to identify data streams, a join type, and join condition. After identifying the data streams to join, the streaming full join agent 104 registers with the data ingestion subsystem 120 to receive notifications when data records for the identified data streams arrive. This presumes a publisher-subscribe architecture for messaging between the subsystems 120, 130 but other messaging patterns or event driven communication can be implemented.

At stage B, the data ingestion subsystem 120, upon detecting receipt/arrival of data records from either one of the data streams 101A, 101B into the data repository 103, provides notification of the arrived data record(s) to the streaming full join agent 104. A notification may provide a record identifier that the streaming full join agent 104 or transformation subsystem 130 can use to read the record or fields of the record relevant to the join operation. Alternatively, the notification can indicate time of receipt and data source identifier in metadata or a notification header and carry the data record in a notification payload. If all of the fields of the data record are not relevant to the transformation/join operation, then the transformation subsystem 130 or streaming full join agent will read the field(s) relevant to the join operation from the data record. For simplicity, the description still refers to the data record even if less than all fields of the data record are relevant to the join operation.

FIG. 1 depicts stages C1 and C2 as alternative stages of operations dependent upon a determination of whether the join condition is satisfied. In either case, the streaming full join agent 104 determines whether an existing data record in the target dataset 105 satisfies the join condition with respect to the arrived data record. In a simple case, the join condition will specify a primary key (e.g., field or column) used to determine whether to join data. In this simple case, the join condition is satisfied if the values of the primary key of an existing data record in the target dataset 105 and the arrived data record matches. This is just one example. In other cases, the join condition specifies a composite key (i.e., multiple fields or columns) for the join condition. At stage C1, the streaming full join agent 104 has determined that the join condition is satisfied by an existing data record in the target dataset 105 with respect to the arrived data record and updates the target dataset 105 combining the fields relevant to the join operation of the arrived data record with the existing data record. If the streaming full join agent 104 determined that the join condition is not satisfied by any existing data record in the target dataset 105, then the streaming full join agent 104 updates the target dataset 105 by adding the arrived data record into the arrived dataset 105.

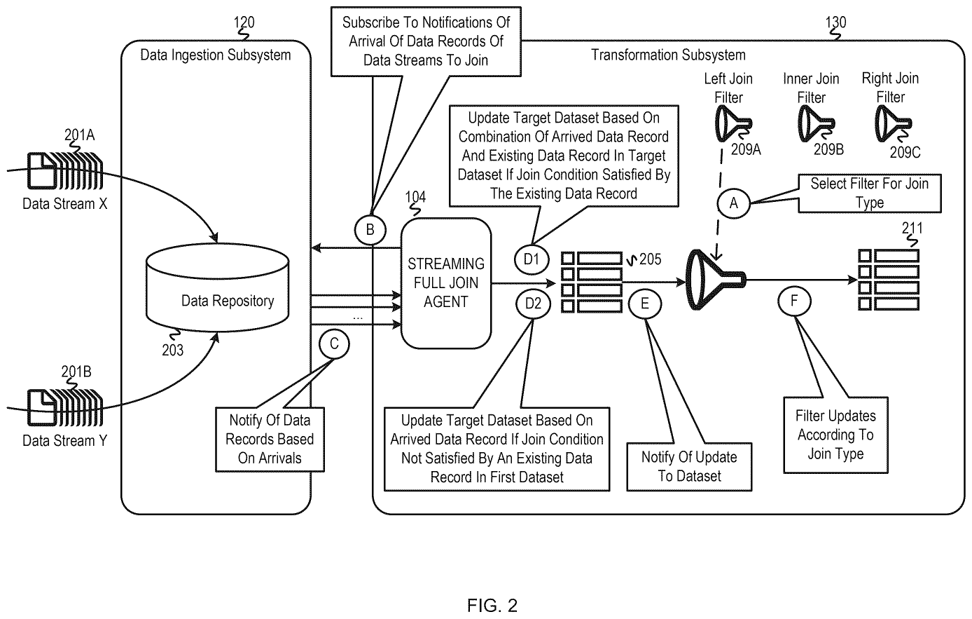

FIG. 2 is a diagram of a system performing a streaming left join on streaming datasets. As in FIG. 1, the diagram depicts two data streams 201A and 201B, labeled “Data Stream X” and “Data Stream Y” respectively feeding data asynchronously into a data repository 203 associated with the data ingestion subsystem 120. The full streaming join agent 104 performs a streaming full join on the data streams 201A, 201B similarly as described in FIG. 1. Agents 209A, 209B and 209C represent a collection of filter agents labeled “Left Join Filter”, “Inner Join Filter”, and “Right Join Filter” respectively. Each of these filter agents 209A-209C represents program code to be instantiated as a thread/process depending upon a type of join specified in a join operation indicated in the transformation flow/pipeline configuration (e.g., indicated in a front end of the transformation subsystem 130 either through a user interface or through internal configuration).

FIG. 2 is annotated with a series of letters A, B, C, D1-D2, E, and F representing stages of one or more operations each. Although these stages are ordered for this example, the stages illustrate one example to aid in understanding this disclosure and should not be used to limit the claims. Subject matter falling within the scope of the claims can vary from what is illustrated.

At stage A, the transformation subsystem 230 loads a specified filter 209A. The selection of a specified filter can be done through configuration of the transformation subsystem 230 or through a user interface. In some cases, a default filter can be applied to the target dataset 205 via configuration of the transformation subsystem 230. A default filter would be a filter (e.g., inner join filter or left join filter) that is defined in a pipeline configuration in advance, as if a template. Different pipelines can be defined with different default filters. A transformation flow could be constructed by selection of the pipeline with the desired filter.

The stages B, C, and D1-D2 in FIG. 2 are substantially similar to stages A, B and C1-C2 of FIG. 1. At stage B, the transformation subsystem 130 subscribes to notifications of new/arriving data records into the data repository 203. At stage C, the data ingestion subsystem 120, upon receiving data from one or multiple data streams, provides an event notification that new data records are available to the transformation subsystem 230. FIG. 2 depicts stages D1 and D2 as alternative stages of operations dependent upon a determination of whether the join condition is satisfied.

At stage E, the streaming full join agent 104 (or a process that maintains the dataset 205) provides notification to the filter 209A of an update to the target dataset 205. The transformation subsystem instantiates the filter 209A (i.e., process or thread instantiated from the filter 209A) to effectuate a left join of the streaming data 201A, 201B. The left join filter 209A can subscribe in a manner as described with respect to stage B in FIG. 1.

At stage F, the left join filter 209A filters the updates to the dataset 205 according to the join type, in this example being a left join. Whichever of the data streams 210A, 210B is indicated as the primary source (i.e., left for the left join operation), will have been determined from the configuration of the join operation. Thus, the filtering decisions by the left join filter 209A are based on whether the update corresponds to a combination or merger of data records or was an update for one of the data streams 201A, 201B. If an update to the dataset 205 corresponds to a combination (i.e., a join), then the left join filter 209A applies the update to the dataset 211. If the update to the dataset 205 corresponds to only one of the data streams 201A, 201B, then the left join filter 209A filters out the update unless it corresponds to the primary data source.

The transformation or flow configuration with streaming join can be indicated in configuration file, such as a YAML or Javascript® Object Notation file. Regardless of the specific language, the transformation subsystem reads the configuration file to perform the streaming join(s) specified in the configuration file for the data streams specified in the configuration file.

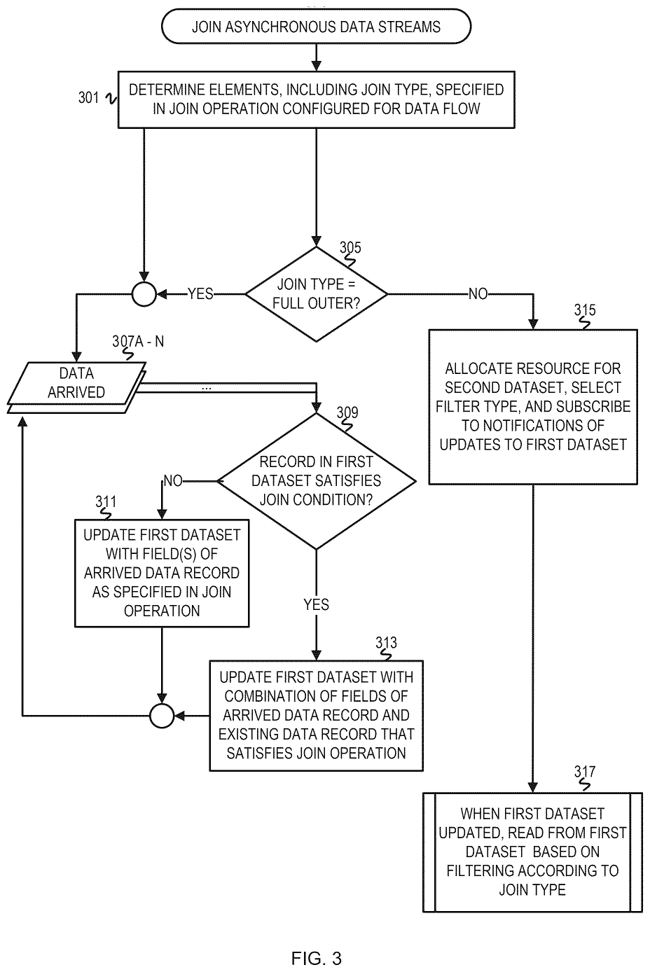

FIGS. 3-5 are flowcharts of example operations for various join operations on streaming data. The example operations are described with reference to a transformation subsystem for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The terms “record” and “data record” are used interchangeably for the purposes of FIGS. 3-5.

FIG. 3 is a flowchart of example operations for joining asynchronously streaming datasets. The example operations correspond to a data transformation flow that transforms data from multiple streams according to a specified join operation.

At block 301, the transformation subsystem determines the type of join operation configured for the data flow. The transformation subsystem reads the configuration data of the data flow to determine elements of a join operation. Elements of a join operation include a type of join, a join condition, and identifiers of data sources (in this case data streams). Additional elements can be a destination or sink for the resulting dataset or target dataset. If the join is specified in a JOIN statement, the transformation subsystem can parse the statement to extract the elements. To receive notifications of arrival of incoming data records of the data sources, the transformation subsystem can, for example, subscribe to a publisher that publishes notifications of data arrival events or periodically poll a memory location for available data records. Operational flow proceeds to blocks 305 and 309 from block 301. However, the flow of operations to 305 is dependent upon availability or arrival of an incoming data record of a data source stream.

If the components/infrastructure are not already provisioned for the data flow, the transformation subsystem establishes components/infrastructure for creating a full join of the identified data streams. For example, the transformation subsystem spawns a process or thread. The transformation subsystem allocates a resource(s) for a first dataset (e.g., requests provision of a repository, table, structure, or cloud-based storage for the first dataset). The allocation of the resource can include indication of a schema according to the schema for the result of a join based on the schemas of the data of the streams. The transformation subsystem subscribes to notifications of new/arriving data records for either of the data streams identified for the join operation. Indication of the publisher of events/messages of data record arrival for either of the data streams can be determined from the data flow configuration.

At block 305, the transformation subsystem determines if the specified type of join operation is a full join operation or not. For a join type other than a full join, the transformation subsystem will establish additional components/infrastructure to effectuate the join based on the results of the streaming full join if not already established. If the join type is a full join, additional infrastructure is not established, and the transformation subsystem operates in response to the notifications 307A-307N. If the specified join type is not a full join, operations continue at block 315. If the specified join type is not a full join, then the operations corresponding to the full join (blocks 309 and either 311 or 313) are performed concurrently with the operations for effectuating the specified join type which start at block 315.

For each of the notifications 307A-307N indicating arrival of a data record (illustrated in FIG. 3 as “data arrived”), the transformation subsystem determines whether a data record in the first dataset satisfies the join condition with respect to the arrived data record at block 309. Depending upon implementation, a notification may provide a data record identifier or reference that the transformation subsystem can use to read the field(s) of the record relevant to the join operation. Or a notification can carry the arrived data record (e.g., as message payload). In the case of a notification carrying the arrived data record, the transformation subsystem would read the relevant field(s). As the relevant field(s) will include the primary or composite key, the transformation subsystem can search the first dataset for an existing data record that satisfies the join condition with respect to the key of the arrived data record. If no data record is found in the first dataset that satisfies the join condition with respect to the arrived data record, then operational flow proceeds to block 311. Otherwise, operational flow proceeds to block 313.

At block 311, the transformation subsystem updates the first dataset with the relevant field(s) of the arrived data record. In some cases, the join operation will specify a subset of the field(s) of a data stream(s) being joined for the join operation, regardless of the specific join type. The specified subset of field(s) is selected to be persisted into the first dataset (i.e., target dataset in the case of a full join). In addition to the relevant field(s), the first dataset will have been established with fields indicating a time of arrival. This metadata can be included in a notification, or the transformation subsystem can query the publisher or repository of the data streams for this metadata. After adding a new record to the first dataset with the relevant field(s) and metadata, the transformation subsystem waits for another notification as represented by a line from block 311 to the notifications 307A-307N. In some cases, the notifications are queued and the transformation subsystem will dequeue a notification and continue to block 309.

At block 313, the transformation subsystem updates the first dataset with a combination of the relevant field(s) of the arrived data record and an existing data record that satisfies the join operation with respect to the arrived data record. Based on the key, the transformation subsystem merges/combines the relevant field(s) of the arrived data record into the existing data record that matches the value of the key. After block 313, the transformation subsystem processes the next notification or waits for the next notification as represented by the dashed line from block 313 to the notifications 307A-307N.

At block 315, the transformation subsystem establishes components/infrastructure for filtering updates to the first dataset and to effectuate the specified join type. The transformation subsystem allocates a resource(s) for a second dataset, which will be the target dataset instead of the first dataset since the join operation specifies a non-full join operation. The transformation subsystem selects a filter based on the join type. For instance, different functions, scripts, code stubs, etc. can be designated for effectuating the different join types that are not full outer join. After being selected, the transformation subsystem subscribes to notifications of updates to the first dataset. Indication of the publisher of updates to the first dataset (e.g., a process that maintains/manages the first dataset) can be determined from the data flow configuration.

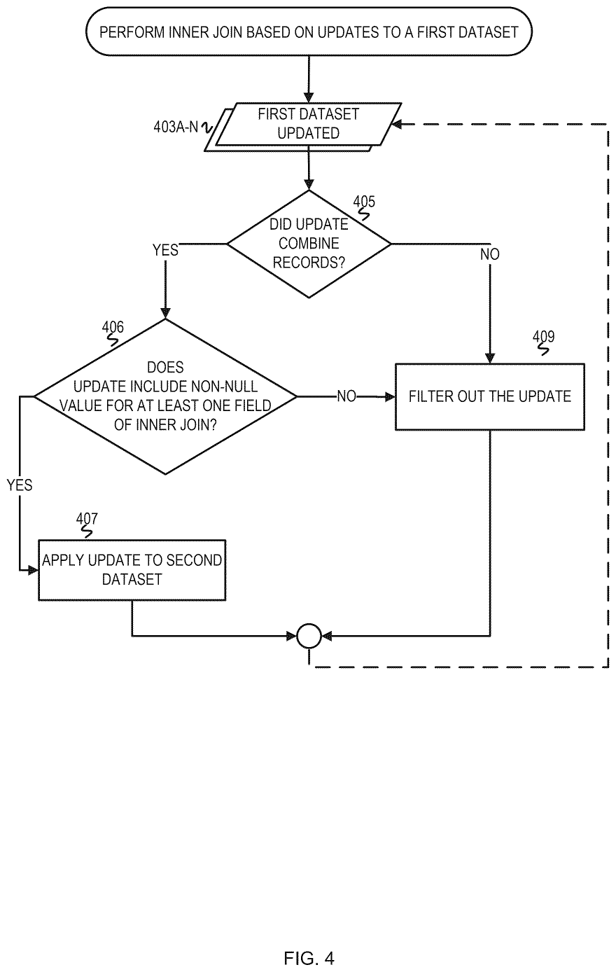

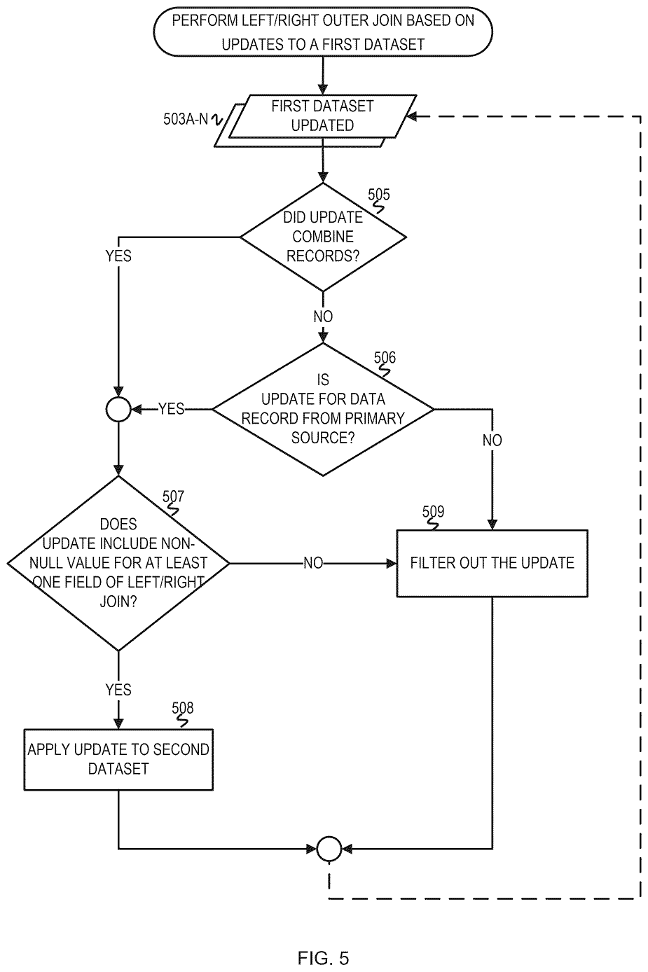

After the infrastructure is established for effectuating the specified join type, the transformation subsystem, upon receiving notification of an update to the first dataset, reads the record corresponding to the update from the first dataset based on the join type. The transformation subsystem will either apply the update or filter out the update. FIGS. 4 and 5 are flowcharts with example operations that elaborate on effectuating a join type that is not a full outer join based on a full outer join dataset.

FIG. 4 is a flowchart of example operations for effectuating an inner join on streaming datasets based on updates to a first dataset that is a full join of the streaming datasets. The example operations are described with respect to a transformation subsystem. The components/infrastructure for the filtering join are presumed to have been established before the operations of FIG. 4.

As updates are made to the first dataset or full join dataset, notifications 403A-403N are received over time indicating the updates. Similar to the notifications in FIG. 3, the notifications 403A-403N may be buffered, communicated as messages, communicated over an event bus, etc. The rest of the example operations are described with respect to receiving the notification 403A. At block 405, the transformation subsystem determines whether the notification 403A indicates the update to the full join dataset was an insert/add or merge/combination. Implementations can determine the type of update differently. For example, a notification can have a flag or value that indicates the type of update. As another example, the transformation subsystem can read the data record corresponding to the update and determine whether the number of fields reflects a combination of data records or whether a data source field indicates more than one data source (e.g., a field can be maintained in the full join dataset that identifies each data stream that contributed to the data record). A streaming inner join will capture combinations of records of source data streams made in the full join dataset if the inner join condition is satisfied. For a non-full outer join, implementations may create a full join dataset with all fields of the data sources regardless of which fields are specified in the join operation. In such implementations, an update which combines records in the full join dataset can include a field(s) not specified by the inner join and may not include any field specified by the inner join. If the transformation subsystem determines that the update to the full join dataset combined records, then operational flow proceeds to block 406. If the update did not combine records, then the update does not satisfy the join type of inner join and operations continue at block 409.

At block 406, the transformation subsystem determines if the record associated with the update includes non-null values for at least one field specified for the inner join. If all fields specified by the inner join are null, then the update does not impact the inner join. If the transformation subsystem maintains a full join dataset according to the inner join configuration (i.e., only fields specified in the inner join), then updates in the full join dataset would have a value for at least one field specified for the inner join. If the transformation subsystem determines that at least one field in the record specified by the inner join is not null, then operational flow continues at block 407. Otherwise, if all fields specified by the inner join are null, operations continue at block 409.

At block 407, the transformation subsystem adds the record associated with the update into the second dataset. In some implementations, the transformation subsystem will not include metadata fields. For example, configuration of the transformation subsystem can specify the timestamp to be excluded or included. Operational flow proceeds, asynchronously, back to block 405 depending on whether another one of the notifications 403A-403N has been received.

At block 409, the transformation subsystem filters out the record associated with the update. The transformation subsystem filters out the data record of the full join dataset corresponding to the update to the full join dataset. Operational flow proceeds, asynchronously, back to block 405 depending on whether another one of the notifications 403A-403N has been received.

FIG. 5 is a flowchart of example operations for effectuating a left/right join on streaming datasets based on updates to a first dataset that is a full join of the streaming datasets. As in FIG. 4, the example operations are described with respect to a transformation subsystem, and it is presumed that components/infrastructure for the filtering join have been established before the operations of FIG. 4. As mentioned earlier, configuration of the transformation for a data flow will indicate which data stream is “left” and which is “right.” In the case of a left join, the “left” data source is the primary data source in these operations, whereas, in the case of a right join, the “right” data source is the primary data source. With the exception of block 506, the majority of operations are similar to those in FIG. 4 and substantially similar details are not repeated.

As updates are made to the full join dataset, notifications 503A-503N are received over time indicating the updates. For simplicity, the example operations are described with respect to receiving the notification 503A. At block 505, the transformation subsystem determines whether the notification 503A indicates the update to the full join dataset was an insert/add or merge/combination. An update which combines records indicates that the join condition was already satisfied whether a left join or a right join. If the left/right join type is satisfied (i.e., the update combined data fields), then operational flow proceeds to block 507. If the update did not combine records, then operations continue at block 506.

At block 506, the transformation subsystem determines if the update to the full join dataset is for a data record from the primary data source. The transformation subsystem will have set a value with the data stream identifier corresponding to the primary data source. Either the notification 503A or the data record in the full join dataset corresponding to the notification 503A will include a data source identifier of the data record. Since the update did not combine, the transformation subsystem will determine whether the data record that was inserted into the full join dataset indicates a data source identifier that matches the identifier of the primary data source. If so, then the update is from the primary data source and operations continue at block 507. Otherwise, operations continue at block 509.

At block 507, the transformation subsystem determines if the record associated with the update includes non-null values for at least one field specified by left/right join. If the record associated with the update includes at least one field specified by the left/right join with a non-null value, then operational flow continues at block 508. Otherwise, operational flow proceeds at block 509.

At block 508, the transformation subsystem adds the record associated with the update into the second dataset. Similar to the operations of FIG. 4, the transformation subsystem can include a subset of the fields of the record into the second dataset based on the configuration of the transformation subsystem, such as only selecting the fields relevant to the join operation and not including either or both the timestamp and data source metadata fields. The transformation subsystem can instead preserve metadata associated with the record externally with respect to the second dataset. Operational flow proceeds, asynchronously, back to block 505 depending on whether another one of the notifications 503A-503N has been received.

At block 509, the transformation subsystem filters out the record associated with the update. The transformation subsystem filters out the data record of the full join dataset corresponding to the update to the full join dataset. Operational flow proceeds, asynchronously, back to block 505 depending on whether another one of the notifications 503A-503N has been received.

### Variations

The examples illustrated in FIGS. 1-5 refer to two data streams or streaming data sources. However, the described streaming joins can be employed in a data pipeline or data transformation flow that joins more than two streaming data sources. For a full join of m data streams (m>2), the full join can be implemented to update a full join dataset T1 as records arrive from any of the m data streams. In other embodiments, the full join can be performed in a cascading manner to create a full join dataset T1 for a pair of data streams A and B and then perform a full join of T1 with another of the data streams C. Different subsets of the m data streams can be fully joined to create datasets and those datasets can be fully joined. For example, A and B can be fully joined to create dataset T1 and C and D can be fully joined to create dataset T2. T1 and T2 would also be fully joined to create dataset T3. Implementations can use pipeline or flow configurations for effectuating the full join of the m data streams. Other types of joins would apply the filter corresponding to the join type to the comprehensive full join data set of the m data streams. Furthermore, compound joins or nested joins can be implemented with pipelines/flows. For example, “Left Join of C and (Full Join (A,B)) can be implemented with a first pipeline that performs a streaming full join of the data streams A and B and a second pipeline that performs a streaming left join on the output of the first pipeline and data stream C.

While the above description refers to the inclusion of some metadata (e.g., a unique data stream identifier and arrival timestamp), this is not necessary. For instance, embodiments can include timestamps, whether for arrival of a record or update of a record, and eschew the inclusion of data stream identifiers.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, which employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

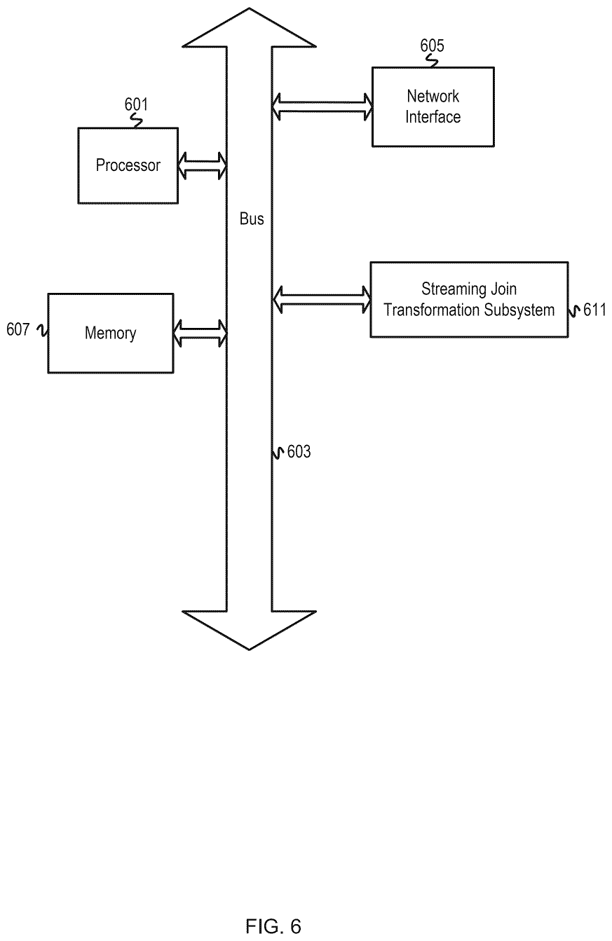

FIG. 6 depicts an example computer system with a streaming join transformation subsystem. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a streaming join transformation subsystem 611. The streaming join transformation subsystem 611 intakes data from multiple data streams and builds a dataset (full join dataset) as data records arrive from any one of the data streams to reflect a full join based on current state of available data records of the multiple data streams. If a join other than a full join is specified for the data transformation, then the streaming join transformation subsystem 611 effectuates the non-full join by selectively filtering updates to the full join dataset according to the type of join that was specified to create the join type specific target dataset. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor 601.

1. A method comprising:
generating a target dataset from a plurality of asynchronous data streams according to a specified join operation that indicates a join condition and join type, wherein generating the target dataset comprises,
for each notification indicating arrival of a data record of one of the plurality of asynchronous data streams,
determining whether an existing data record in a first dataset satisfies the join condition with respect to a first arrived data record corresponding to the notification;
based on determining that an existing record does not satisfy the join condition with respect to the first arrived data record, updating the first dataset based on the first arrived data record; and
based on determining that an existing data record in the first dataset satisfies the join condition with respect to the first arrived data record, updating the first dataset based on a combination of the first arrived data record and the existing data record that satisfies the join condition with respect to the first arrived data record.

2. The method of claim 1 further comprising:
after updating the first dataset, updating a second dataset according to the join type, wherein the join type is not a full outer join and wherein updating the second dataset comprises filtering updates to the first dataset for applying to the second dataset based on the join type and the join condition.

3. The method of claim 2, wherein filtering updates to the first dataset for applying to the second dataset comprises:
applying the update if the first arrived data record corresponds to a primary data stream specified in the join operation and the join type is an outer join; and
filtering out the update to the first dataset if the join type is inner join or the join type is outer join and the first arrived data record does not correspond to the primary data stream.

4. The method of claim 2 further comprising determining the join type and instantiating an agent to update the second dataset if the join type is not full outer join.

5. The method of claim 1, wherein updating the first dataset based on the first arrived data record comprises inserting a data record into the first dataset with each data field indicated for the join operation and wherein updating the first dataset based on a combination of the first arrived data record and the existing data record comprising combining data fields of the first arrived data record and the existing data record indicated for the join operation.

6. The method of claim 1, wherein updating the first dataset comprises indicating a timestamp for the first arrived data record.

7. The method of claim 1 further comprising ingesting, into a set of one or more data repositories, data records of the plurality of asynchronous data streams that arrive over time and generating the notifications corresponding to arrivals.

8. The method of claim 7 further comprising subscribing, by a first subsystem that maintains the first dataset, to notifications of arrival of data records for each of the plurality of asynchronous data streams, wherein the ingesting and generating the notifications is by a second subsystem.

9. A non-transitory, machine-readable medium having program code stored thereon, the program code comprising instructions to:
subscribe to notifications of arrival of data records of a plurality of data streams according to a join operation configuration for a data transformation flow, wherein the join operation configuration indicates a join condition and join type;
in response to a notification,
determine whether an existing data record in a first dataset satisfies the join condition with respect to a first arrived data record corresponding to the notification;
based on a determination that an existing data record does not satisfy the join condition with respect to the first arrived data record, update the first dataset based on the first arrived data record; and
based on a determination that an existing data record in the first dataset satisfies the join condition with respect to the first arrived data record, update the first dataset based on a combination of the first arrived data record and the existing data record that satisfies the join condition with respect to the first arrived data record.

10. The non-transitory, machine-readable medium of claim 9, wherein the program code further comprises instructions to:
after updating the first dataset and determining that the join type is not full outer join, update a second dataset according to the join type, wherein the instructions to update the second dataset comprise instructions to filter an update from the first dataset to the second dataset based on the join type and the join condition.

11. The non-transitory, machine-readable medium of claim 10, wherein the instructions to filter the update from the first dataset to the second dataset comprise instructions to:
apply to the second dataset the update if the first arrived data record corresponds to a primary data stream specified in the join operation and the join type is an outer join; and
filter out the update from the first dataset if the join type is inner join or the join type is outer join and the first arrived data record does not correspond to the primary data stream.

12. The non-transitory, machine-readable medium of claim 10, wherein the program code further comprises instructions to determine the join type and instantiate an agent to update the second dataset after determining that the join type is not full outer join and subscribe the instantiated agent to notifications of updates to the first dataset.

13. The non-transitory, machine-readable medium of claim 9, wherein the instructions to update the first dataset based on the first arrived data record comprise instructions to insert a data record into the first dataset with each data field indicated for the join operation and wherein instructions to update the first dataset based on a combination of the first arrived data record and the existing data record comprise instructions to combine data fields of the first arrived data record and the existing data record indicated for the join operation.

14. The non-transitory, machine-readable medium of claim 9, wherein the instructions to update the first dataset comprise instructions to indicate a timestamp for the first arrived data record.

15. A system comprising:
a first processor; and
a first machine-readable medium having instructions stored thereon that are executable by the first processor to,
subscribe to notifications of arrival of data records of a plurality of data streams according to a join operation configuration for a data transformation flow, wherein the join operation configuration indicates a join condition and join type; and
in response to a notification,
determine whether an existing data record in a first dataset satisfies the join condition with respect to a first arrived data record corresponding to the notification;
based on a determination that an existing data record does not satisfy the join condition with respect to the first arrived data record, update the first dataset based on the first arrived data record; and
based on a determination that an existing data record in the first dataset satisfies the join condition with respect to the first arrived data record, update the first dataset based on a combination of the first arrived data record and the existing data record that satisfies the join condition with respect to the first arrived data record.

16. The system of claim 15 further comprising:
a second processor; and
a second machine-readable medium having instructions stored thereon that are executable by the second processor to,
ingest, into a set of one or more data repositories, the data records of the plurality of data streams based on arrival and generate the notifications.

17. The system of claim 15, wherein the first machine-readable medium further has stored thereon instructions to:
determine whether the join type is full outer join; and
after updating the first dataset and a determination that the join type is not full outer join, update a second dataset according to the join type, wherein the instructions to update the second dataset comprise instructions to filter an update from the first dataset to the second dataset based on the join type and the join condition.

18. The system of claim 17, wherein the instructions to filter the update from the first dataset to the second dataset comprise the instructions being executable by the first processor to:
apply the update if the first arrived data record corresponds to a primary data stream specified in the join operation and the join type is an outer join; and
filter out the update from the first dataset if the join type is inner join or the join type is outer join and the first arrived data record does not correspond to the primary data stream.

19. The system of claim 15, wherein the instructions to update the first dataset based on the first arrived data record comprise the instructions being executable by the first processor to insert a data record into the first dataset with each data field indicated for the join operation and wherein instructions to update the first dataset based on a combination of the first arrived data record and the existing data record comprise the instructions being executable by the first processor to combine data fields of the first arrived data record and the existing data record indicated for the join operation.

20. The system of claim 15, wherein the instructions to update the first dataset comprise the instructions being executable by the first processor to indicate a timestamp.
